(19) United States
(12) Patent Application Publication
(10) Pub. No.: US 2012/0314652 A1
(43) Pub. Date: Dec. 13, 2012

(54) APPARATUS AND METHOD FOR PERFORMING RANDOM ACCESS IN WIRELESS COMMUNICATION SYSTEM

(75) Inventors: Jae Hyun AHN, Seoul (KR); Ki Bum KWON, Seoul (KR); Myung Cheul JUNG, Seoul (KR)

(73) Assignee: PANTECH CO., LTD., Seoul (KR)

(21) Appl. No.: 13/491,938

(22) Filed: Jun. 8, 2012

(30) Foreign Application Priority Data
Jun. 9, 2011 (KR) 10-2011-0055612
Jan. 31, 2012 (KR) 10-2012-0009475

(51) Int. Cl. H04W 74/08; H04W 88/08

(52) U.S. Cl. 370/328

(57) ABSTRACT

An apparatus and method for performing a random access in a wireless communication system are provided. The method includes: transmitting a random access preamble on at least one serving cell to a base station; and receiving a random access response message including a plurality of timing advance information applied to each of the at least one serving cell and information on a serving cell to which the plurality of timing advance information is applied as a response to the random access preamble from the base station. The mobile station receives timing information for uplink synchronization through a plurality of serving cells, thereby making it possible to perform the uplink synchronization with the base station. In addition, it is possible to more efficiently configure the random access response message transmitted to the mobile station by the base station in order to perform the uplink synchronization.

### CROSS-REFERENCE TO RELATED APPLICATIONS

This application claims the benefit of priority of Korean Patent Application No. 10-2011-0055612 filed on Jun. 9, 2011, and No. 10-2012-0009475 filed on Jan. 31, 2012 all of which is incorporated by reference in its entirety herein.

### BACKGROUND OF THE INVENTION

1. Field of the Invention

The present invention relates to wireless communication, and more particularly, to an apparatus and method for performing a random access in a wireless communication system.

2. Discussion of the Related Art

In a general wireless communication system, only a single carrier is mainly considered even though bandwidths of an uplink and a downlink are set to different from each other. The 3rd generation partnership project (3GPP) long term evolution (LTE) is also based on a single carrier, such that each of the numbers of carriers configuring the uplink and the downlink is 1 and bandwidths of the uplink and the downlink are generally symmetrical to each other. In this single carrier system, a random access has been performed using a single carrier. However, recently, as a multiple carrier system is introduced, the random access may be implemented through several component carriers.

The multiple carrier system means a wireless communication system that may support carrier aggregation. The carrier aggregation, which is a technology for efficiently using a segmented small band, is to generate an effect such as using a logically large band by bundling a plurality of physically non-continuous bands in a frequency domain.

An object of a random access process to a network performed by a mobile station may be initial access, handover, scheduling request, timing alignment, or the like.

### SUMMARY OF THE INVENTION

The present invention provides an apparatus and method for performing a random access in a wireless communication system.

The present invention also provides an apparatus and method for performing a random access in a wireless communication system, transmitting timing advance related information applied to a plurality of secondary serving cells.

The present invention also provides an apparatus and method for transmitting random access response messages each indicating timing alignment values of a plurality of secondary serving cells.

In an aspect, a method for performing a random access by a mobile station in a wireless communication system is provided. The method includes: transmitting a random access preamble on at least one serving cell to a base station; and receiving a random access response message including a plurality of timing advance information applied to each of the at least one serving cell and information on a serving cell to which the plurality of timing advance information is applied as a response to the random access preamble from the base station.

The random access response message may further include a cell index field or a frequency index field indicating information on a serving cell to which the plurality of timing advance information is applied.

The random access response message may further a serving cell type indicator indicating whether the plurality of timing advance information is related to a primary serving cell or a secondary serving cell.

The random access response message may include a plurality of MAC control elements, and at least one of the plurality of MAC control elements may include a bundle indicator indicating whether it is a first MAC control element in a bundle of MAC control elements.

In another aspect, a mobile station for performing a random access in a wireless communication system is provided. The mobile station includes: a transmitter transmitting a random access preamble on at least one serving cell to a base station; and a receiver receiving a random access response message including a plurality of timing advance information applied to each of the at least one serving cell and information on a serving cell to which the plurality of timing advance information is applied as a response to the random access preamble from the base station.

In still another aspect, a method for performing a random access by a base station in a wireless communication system is provided. The method includes: receiving a random access preamble on at least one serving cell from a mobile station; and transmitting a random access response message including a plurality of timing advance information applied to each of the at least one serving cell and information on a serving cell to which the plurality of timing advance information is applied as a response to the random access preamble to the mobile station.

In still another aspect, a base station for performing a random access in a wireless communication system is provided. The base station includes: a receiver receiving a random access preamble on at least one serving cell from a mobile station; a processor configuring a random access response message including a plurality of timing advance information applied to each of the at least one serving cell and information on a serving cell to which the plurality of timing advance information is applied as a response to the random access preamble; and a transmitter transmitting the random access response message to the mobile station.

### BRIEF DESCRIPTION OF THE DRAWINGS

FIG. 1 shows a wireless communications system according to the present invention.

FIG. 2 shows an example of a protocol structure for supporting multiple carriers according to the present invention.

FIG. 3 shows an example of a frame structure for a multiple carrier operation according to the present invention.

FIG. 4 shows linkage between a downlink component carrier and an uplink component carrier in a multiple carrier system according to the present invention.

FIG. 5 is a diagram showing an example of timing advance in a synchronizing process according to the present invention.

FIG. 6 is a diagram showing a process of applying uplink timing alignment values using downlink timing alignment values of a primary serving cell and a secondary serving cell.

FIG. 7 is a flow chart explaining a random access procedure according to an exemplary embodiment of the present invention.

FIG. 8 is a flow chart explaining a random access procedure according to another exemplary embodiment of the present invention.

FIG. 9 is a diagram comparing a cell index and a frequency index with each other according to the present invention.

FIG. 10 shows an example of an RAPID MAC sub-header according to the present invention.

FIG. 11 shows an example of a BI MAC sub-header according to the present invention.

FIG. 12 shows an example of a structure of an MAC control element included in a random access response message according to the present invention.

FIG. 13 shows another example of a structure of an MAC control element included in a random access response message according to the present invention.

FIG. 14 shows still another example of a structure of an MAC control element included in a random access response message according to the present invention.

FIG. 15 shows still another example of a structure of an MAC control element included in a random access response message according to the present invention.

FIG. 16 shows another example of a structure of an MAC control element included in a random access response message according to the present invention.

FIG. 17 shows a structure of an MAC PDU for a random access response and a mapping structure between an RAPID and the random access response.

FIG. 18 shows MAC control elements present in a bundle according to the present invention.

FIG. 19 is a flow chart showing an operation of a mobile station performing the random access procedure according to the exemplary embodiment of the present invention.

FIG. 20 is a flow chart showing an operation of a base station performing the random access procedure according to the exemplary embodiment of the present invention.

FIG. 21 is a block diagram showing the base station and the mobile station performing the random access procedure according to the exemplary embodiment of the present invention.

### DETAILED DESCRIPTION OF THE EMBODIMENTS

Hereinafter, some exemplary embodiments in the present invention will be described in detail with reference to the illustrative drawings. It is to be noted that in adding reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

In addition, in describing components of exemplary components of the present invention, terms such as first, second, A, B, (a), (b), etc. can be used. These terms are used only to differentiate the components from other components. Therefore, the nature, times, sequence, etc. of the corresponding components are not limited by these terms. When any components are “connected”, “coupled”, or “linked” to other components, it is to be noted that the components may be directly connected or linked to other components, but the components may be “connected”, “coupled”, or “linked” to other components via another component therebetween.

Further, the present specification describes a wireless communication network as an object. An operation performed in the wireless communication network may control a network in a system (for example, a base station) supervising corresponding wireless communication networks and may be performed during a process of transmitting data or performed in mobile stations coupled with the corresponding wireless networks.

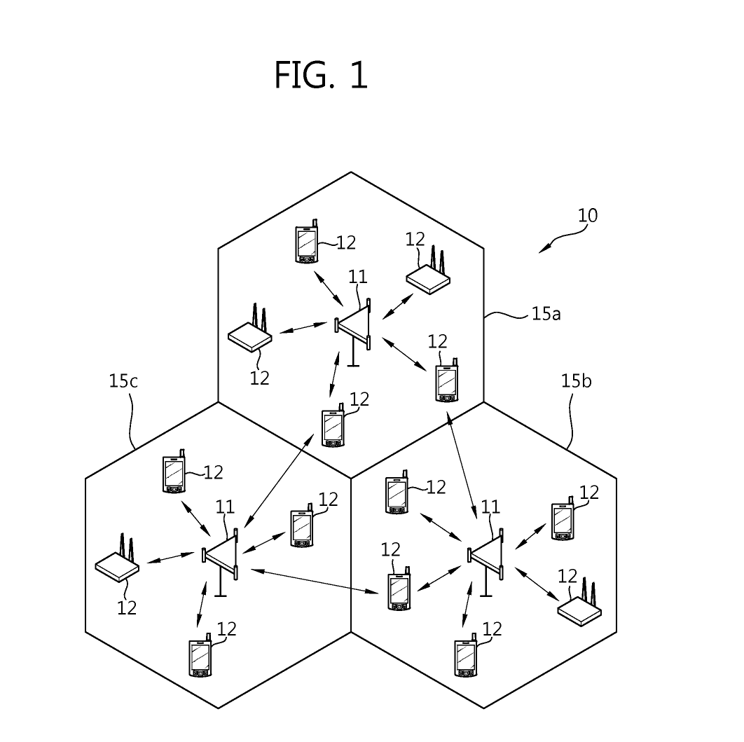

FIG. 1 shows a wireless communications system according to the present invention.

Referring to FIG. 1, the wireless communication system 10 is widely distributed in order to provide various communication services, such as audio, packet data, or the like. A wireless communication system 10 includes at least one base station (BS) 11. Each base station 11 provides communication services to specific cells 15a, 15b, and 15c. The cell may again be divided into a plurality of areas (referred to as sectors).

A mobile station (MS) 12 may be fixed or moved and may be referred to as other terms, such as a user equipment (UE), a mobile terminal (MT), a user terminal (UT), a subscriber station (SS), a wireless device, a personal digital assistant (PDA), a wireless modem, a handheld device, or the like. The base station 11 may be referred to as other terms, such as an evolved-Node B (eNB), a base transceiver system (BTS), an access point, a femto base station, a home nodeB, a relay, or the like. The cell is to be interpreted as comprehensive meaning indicating a partial area covered by the base station 11 and means including all of the various coverage areas such as a mega cell, a macro cell, a micro cell, a pico cell, a femto cell, or the like.

Hereinafter, a downlink means communication from the base station 11 to the mobile station 12, and an uplink means communication from the mobile station 12 to the base station 11. At the downlink, a transmitter may be a portion of the base station 11, and a receiver may be a portion of the mobile station 12. At the uplink, the transmitter may be a portion of the mobile station 12, and the receiver may be a portion of the base station 11. A multiple access method applied to the wireless communication system is not limited. Various multiple access methods such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, OFDM-CDMA, or the like, may be used. In the uplink transmission and the downlink transmission, a time division duplex (TDD) scheme of performing transmission at different times or a frequency division duplex (FDD) scheme of performing transmission at different frequencies may be used.

Carrier aggregation (CA), which supports a plurality of carriers, is also referred to as spectrum aggregation or bandwidth aggregation. An individual unit carrier bundled by the carrier aggregation is referred to as component carrier (CC). Each component carrier is defined by a bandwidth and a center frequency. The carrier aggregation is introduced in order to support increasing throughput, prevent an increase in cost due to the introduction of a broadband radio frequency (RF) device, and secure compatibility with existing systems. For example, when five component carriers are allocated as granularity in a carrier unit having a bandwidth of 20 MHz, a bandwidth of maximum 100 MHz may be supported.

The carrier aggregation may be classified into contiguous carrier aggregation performed between continuous component carriers in frequency domain and non-continuous carrier aggregation performed between discontinuous component carriers. The numbers of carriers aggregated in the downlink and the uplink may be set to be different from each other. The case in which the number of downlink component carriers and the number of uplink component carriers are the same as each other may be referred to as symmetric aggregation and the case in which the number of downlink component carriers and the number of uplink component carriers are different from each other may be referred to asymmetric aggregation.

In addition, sizes (that is, bandwidths) of the component carriers may be different from each other. For example, when five component carriers are used to configure a 70 MHz band, they may be configured of 5 MHz component carrier (carrier #0)+20 MHz component carrier (carrier#1)+20 MHz component carrier (carrier#2)+20 MHz component carrier (carrier#3)+5 MHz component carrier (carrier#4).

Hereinafter, the multiple carrier system indicates a system supporting the carrier aggregation. In the multiple carrier system, the contiguous carrier aggregation and/or the non-contiguous carrier aggregation may be used, and either of the symmetric aggregation or the asymmetric aggregation may be used.

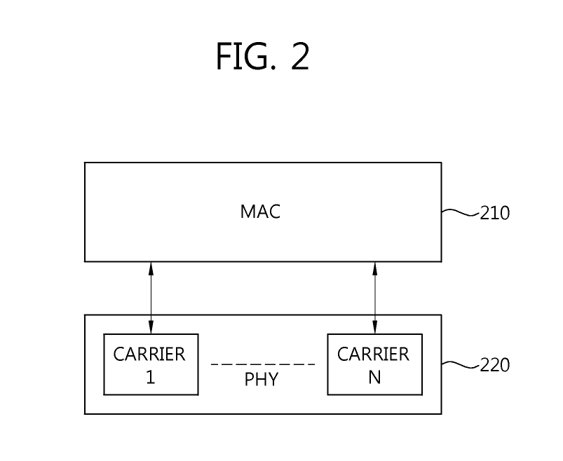

FIG. 2 shows an example of a protocol structure for supporting multiple carriers according to the present invention.

Referring to FIG. 2, a common medium access control (MAC) entity 210 manages a physical layer 220 that uses a plurality of carriers. An MAC management message transmitted by a specific carrier may be applied to other carriers. That is, the MAC management message is a message that may include the specific carrier to control other carriers. The physical layer 220 may be operated by time division duplex (TDD) and/or frequency division duplex (FDD).

There are some physical control channels used in the physical layer 220. A physical downlink control channel (PDCCH) informs the mobile station of information on resource allocation of a paging channel (PCH) and a downlink shared channel (DL-SCH) and hybrid automatic repeat request (HARQ) associated with the DL-SCH. The PDCCH may carry an uplink grant informing the mobile station of the resource allocation of the uplink transmission. A physical control format indicator channel (PCFICH) informs the mobile station of the number of OFDM symbols used for the PDCCHs and is transmitted for each subframe. A physical hybrid ARQ indicator channel (PHICH) carries HARQ ACK/NAK signals as a response of the uplink transmission. A physical uplink control channel (PUCCH) carries uplink control information such as HARQ ACK/NAK for downlink transmission, scheduling request, CQI, or the like. A physical uplink shared channel (PUSCH) carries an UpLink shared channel (UL-SCH). A physical random access channel (PRACH) carries a random access preamble.

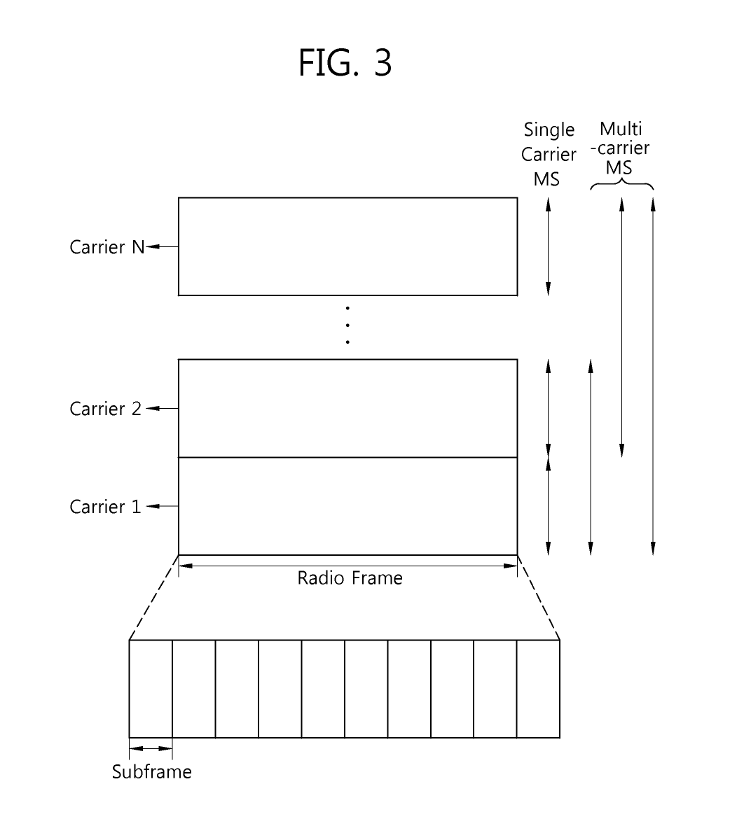

FIG. 3 shows an example of a frame structure for a multiple carrier operation according to the present invention.

Referring to FIG. 3, a frame is configured of ten subframes. The subframe includes a plurality of OFDM symbols. Each carrier may have its own control channel (for example, PDCCH). The multiple carriers may be contiguous to each other or may not be contiguous to each other. The mobile station may support one or more carrier according to its own capability.

The component carrier may be divided into a primary component carrier (PCC) and a secondary component carrier (SCC) according to whether or not it is activated. The primary component carrier is a carrier that is being activated at all times, and the secondary component carrier is a carrier that is activated/inactivated according to specific conditions. The activation means a state in which transmission or reception of traffic data is performed or is ready. The inactivation means a state in which the transmission or reception of the traffic data may not be performed but measurement or transmission or reception of minimum information may be performed. The mobile station may use only a single primary component carrier or one or more secondary component carrier together with the primary component carrier. The mobile station may be allocated with the primary component carrier and/or the secondary component carrier from the base station.

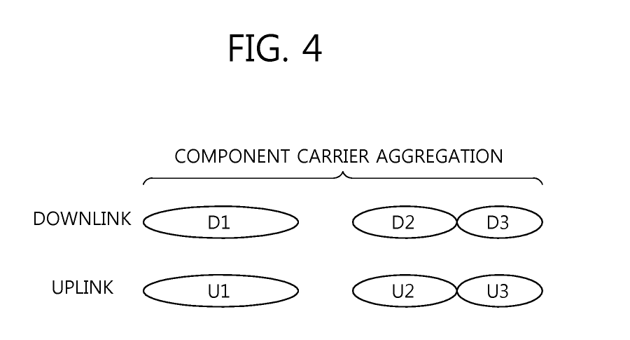

FIG. 4 shows linkage between a downlink component carrier and an uplink component carrier in a multiple carrier system according to the present invention.

Referring to FIG. 4, downlink component carriers D1, D2, and D3 are aggregated in the downlink and uplink component carriers U1, U2, and U3 are aggregated in the uplink. Here, Di is an index of the downlink component carrier, and Ui is an index of the uplink component carrier (i=1, 2, 3). At least one downlink component carrier is the primary component carrier, and the remainders are the secondary component carrier. Likewise, at least one uplink component carrier is the primary component carrier, and the remainders are the secondary component carrier. For example, D1 and U1 are the primary component carriers, and D2, U2, D3, and U3 are the secondary component carriers.

In the FDD system, the downlink component carrier and the uplink component carrier are linked therebetween on a one-to-on basis. For example, the D1 and the U1, the D2 and the U2, and the D3 and the U3 are linked therebetween on a one-to-one basis, respectively. The mobile station performs the linkage between the downlink component carriers and the uplink component carriers through system information transmitted by a logical channel BCCH and mobile station dedicated RRC messages transmitted by DCCH. Each linkage may be set to be cell specific or may be set to be MS specific.

Although FIG. 4 shows only the one-to-one linkage between the downlink component carrier and the uplink component carrier by way of example, a 1: n or n:1 linkage may also be established. Further, an index of the component carriers does not necessarily correspond to an order of the component carriers or a position of frequency bands of corresponding component carriers.

A mobile station that is in a radio resource control (RRC) idle mode may not aggregate the component carriers and may aggregate the component carriers only in an RRC connection mode. The mobile station selects one cell based on several conditions in order to perform radio resource control connection before aggregating the component carriers. Cell selection conditions of the mobile station are as follows.

First, the mobile station may select the most suitable cell that will attempt RRC connection based measured measurement information. As the measurement information, the mobile station considers both of reference signal receiving power (RSRP) in which receiving power is measured based on a received cell-specific reference signal (CRS) of a specific cell and reference signal receiving quality (RSRQ) defined as a ratio of an RSRP value of the specific cell to the entire receiving power. Therefore, the mobile station secures the RSRP and RSRQ values for each of the identifiable cells to select the suitable cell based on the above-mentioned values. For example, the mobile station may set a weight (for example 7:3) with respect to cells in which both of the RSRP and RSRQ values are 0 dB or more and the RSRP value is the largest or the RSRQ is the largest or each of the RSRP and RSRQ values select a suitable cell based on an average value considering the weight.

Second, the mobile station may attempt the radio resource control connection using information on a service operator (such as public land mobile network (PMLN)) stored in an internal memory thereof and fixedly set in a system, downlink center frequency information, or cell identifying information (for example, a physical cell ID). The stored information may be configured of information on a plurality of service operators and cells, wherein each information may have a priority or a preferential weight set thereto.

Third, the mobile station may receive system information from the base station through a broadcasting channel (BCH) and confirm the system information to attempt the radio resource control connection. For example, the mobile station confirms whether or not a cell is a specific cell (for example, a closed subscriber group (CSG), a non-allowed home eNB, or the like) requiring membership in being accessed. Therefore, the mobile station receives the system information transmitted by each base station to confirm CSG ID information indicating whether or not the cell is the CSG. When it is confirmed that the cell is CSG, the mobile station confirms whether the cell is an accessible CSG. In order to confirm access possibility, the mobile station may use its membership information and unique information (for example, an evolved-cell global ID (E-CGI) or PCI information in the system information) of the CSG cell. In the case in which it is confirmed through the confirmation procedure that a base station is an inaccessible base station, the mobile station does not attempt the radio resource control connection.

Fourth, the mobile station may attempt the radio resource control connection through effective component carriers (for example, component carriers capable of being configured in a frequency band that may be supported on implementation by the mobile station) stored in the internal memory thereof.

The second and fourth conditions among the above-mentioned selection conditions may be optionally applied; however, the first and third conditions thereamong may be mandatorily applied.

In order to attempt the radio resource control connection through the cell selected for the RRC connection, the mobile station needs to confirm an uplink band through which an RRC connection request message is to be transmitted. Therefore, the mobile station receives the system information through a broadcasting channel transmitted through a downlink of the selected cell. A system information block 2 (SIB2) includes bandwidth information and center frequency information on a band to be used in the uplink. Therefore, the mobile station attempts the RRC connection through the downlink and uplink of the selected cell and the uplink band connection-set through the information in the SIB2. In this case, the mobile station may transfer the RRC connection request message to the base station during a random access procedure.

In the case in which the RRC connection procedure succeeds, the RRC established cell may be called a primary serving cell, which is configured of a downlink primary component carrier and an uplink primary component carrier.

The primary serving cell means one serving cell providing security input and non-access stratum (NAS) mobility information in an RRC connection or re-connection. According to capabilities of the mobile station, at least cell may be configured to form a set of serving cells together with the primary serving cell, wherein the at least cell is called a secondary serving cell.

Therefore, a set of serving cells set for a single mobile station may be configured only of a single primary serving cell or a single primary serving cell and at least one secondary serving cell.

A downlink component carrier corresponding to the primary serving cell is called a downlink primary component carrier (DL PCC), and an uplink component carrier corresponding to the primary serving cell is called an uplink primary component carrier (UL PCC). Further, in the downlink, a component carrier corresponding to the secondary serving cell is called a downlink secondary component carrier (DL SCC), and in the uplink, a component carrier corresponding to the secondary serving cell is called an uplink secondary component carrier (UL SCC). Only the downlink component carrier may correspond to the single serving cell or both of the DL CC and the UL CC may correspond thereto.

Therefore, in a carrier system, the concept that communication between the mobile station and the base station is performed through the DL CC or the UL CC is the same as the concept that the communication between the mobile station and the base station is performed through the serving cell. For example, in a method for performing a random access according to the present invention, the concept that the mobile station transmits a preamble using the UL CC may be considered as the same concept as the concept that the mobile station transmits the preamble using the primary serving cell or the secondary serving cell. Further, the concept that the mobile station receives downlink information using the DL CC may be considered as the same concept as the concept that the mobile station receives the downlink information using the primary serving cell or the secondary serving cell.

Meanwhile, the primary serving cell and the secondary serving cell have the following characteristics.

First, the primary serving cell is used to transmit the PUCCH. On the other hand, the secondary serving cell may not transmit the PUCCH; however, it may transmit partial control information in information in the PUCCH through the PUSCH.

Second, the primary serving cell is always being activated. On the other hand, the secondary serving cell is a carrier activated/inactivated according to a specific condition. The specific condition may be the case in which an activating/inactivating MAC control element message of the base station is received or an inactivating timer in the mobile station expires.

Third, when the primary serving cell experiences radio link failure (RLF), RRC reconnection is triggered. On the other hand, when the secondary serving cell experiences the RLF, the RRC reconnection is not triggered. The RLF occurs in the case in which downlink performance is maintained at a threshold or less for a predetermined time or more or a random access channel (RACH) fails by the number of times of a threshold or more.

Fourth, the primary serving cell may be changed by a security key change or a handover procedure accompanied with the RACH procedure. However, in the case of a contention resolution (CR) message, only a downlink control channel (PDCCH) indicating CR may be transmitted through the primary serving cell, and CR information may be transmitted through the primary serving cell or the secondary serving cell.

Fifth, NAS information is received through the primary serving cell.

Sixth, in the primary serving cell, the DL PCC and the UL PCC are always configured in pair.

Seventh, each mobile station may set different CC as the primary serving cell.

Eighth, procedures such as reconfiguration, adding, removal, and the like, of the secondary serving cell may be performed by a radio resource control (RRC) layer. In adding a new secondary serving cell, RRC signaling may be used to transmit system information of a dedicated secondary serving cell.

Ninth, the primary serving cell may provide both of the PDCCH (for example, downlink allocation information or uplink grant information) allocated to a MS-specific search space set in order to transmit control information only to a specific mobile station in an area in which the control information is transmitted and the PDCCH (for example, system information (SI), random access response (RAR), and transmit power control (TPC)) allocated to a common search space set in order to transmit the control information to all mobile stations in the cell or a plurality of mobile stations that are in accordance with a specific condition. On the other hand, in the secondary serving cell, only a MS-specific search space may be set. That is, since the mobile station may not confirm a common search space through the secondary serving cell, it may not receive control information transmitted only through the common search space and data information indicated by the control information.

The sprit of the present invention regarding characteristics of the primary serving cell and the secondary serving cell is not limited to the above-mentioned description that is only an example, but may include more examples.

Hereinafter, timing advance (TA) for synchronization acquisition will be described.

In a wireless communication environment, a propagation delay is generated during a process in which an electric wave is propagated from a transmitter and transferred to a receiver. Therefore, even though both of the transmitter and the receiver recognize a time at which the electric wave is propagated from the transmitter, a time at which the electric wave arrives at the receiver is affected by a distance between the transmitter and the receiver, a surrounding propagation environment, or the like, and is changed over time in the case in which the receiver moves. In the case in which the receiver does not accurately recognizes a point in time at which a signal transferred by the transmitter is received, the receiver fails to receive the signal or receives a distorted signal even though it receives the signal, such that communication is impossible.

Therefore, in the wireless communication system, the base station and the mobile station need to be necessarily synchronized with each other in order to receive an information signal regardless of the downlink/uplink. As a kind of synchronization, there are various synchronizations such as frame synchronization, information symbol synchronization, sampling period synchronization, and the like. The sampling period synchronization is synchronization that needs to be the most basically acquired in order to identify physical signals.

The downlink synchronization acquisition may be performed in the mobile station based on a signal of the base station. The base station transmits a mutually promising specific signal so as to allow the mobile station to easily acquire the downlink synchronization. The mobile station needs to accurately recognize a time at which the specific signal is transmitted from the base station. In the case of the downlink, since a single base station simultaneously transmits the same synchronization signal to a plurality of mobile stations, each of the mobile stations may independently acquire the synchronization.

In the case of the uplink, the base station receives signals transmitted from the plurality of mobile stations. In the case in which distances between each mobile station and base station are different, the signals received by each base station have different transmission delay times, and in the case in which each mobile station transmits the uplink information based on the acquired downlink synchronization, information of each mobile station is received in corresponding base stations at different times. In this case, the base station may not acquire the synchronization based any one mobile station. Therefore, in order to acquire the uplink synchronization, a procedure different from a procedure for acquiring the downlink synchronization is required.

Meanwhile, the necessities for the uplink synchronization acquisition may be different according to each multiple access scheme. For example, in the case of a CDMA system, even though the base station receives the uplink signals of different mobile stations at different times, the base station may separate the respective uplink signals from each other. However, in an OFDMA or FDMA based wireless communication system, the base station simultaneously receives the uplink signals of all of the mobile stations and demodulates them at a time. Therefore, the more accurate the time at which the uplink signals of the plurality of mobile stations are received, the higher the reception performance, and the larger the difference between times at which the signals of each mobile station are received, the lower the reception performance. Therefore, it is necessary to acquire the uplink synchronization.

A random access procedure is performed in order to acquire the uplink synchronization, and the mobile station acquires the uplink synchronization based on a timing alignment value transmitted from the base station during the random access process. This is called timing advance (TA). The timing advance is also called timing alignment.

When the uplink synchronization is acquired, the mobile station starts a timing alignment timer (TAT). When the timing alignment timer is being operated, the mobile station and the base station are in a state in which the uplink synchronization therebetween is made. When the timing alignment timer expires or is not operated, the mobile station and the base station regards that they are not synchronized with each other, and the mobile station does not perform the uplink transmission other than transmission of a random access preamble.

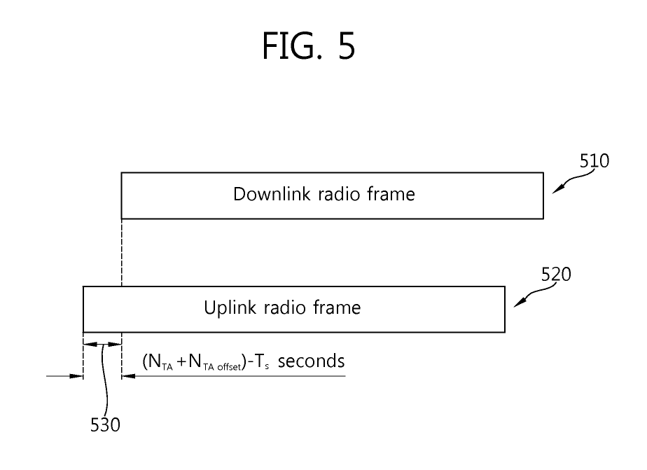

FIG. 5 is a diagram showing an example of timing advance in a synchronizing process according to the present invention.

Referring to FIG. 5, an uplink radio frame 520 needs to be transmitted at a point in time at which a downlink radio frame 510 is transmitted in order to perform communication between the base station and the mobile station. In consideration of a timing difference generated due to a propagation delay between the mobile station and the base station, the mobile station transmits the uplink radio frame 520 at a time earlier than the point in time at which the downlink radio frame 510 is transmitted, thereby making it possible to apply the timing advance so that the base station and the mobile station are synchronized with each other.

The timing advance (TA) at which the mobile station adjusts uplink timing may be calculated by the following Equation 1.

TA=(N_{TA}+N_{TA offset}+Tₛ Equation 1

Where N_{TA} which is a timing alignment value is variably controlled by a timing advance command of the base station, and N_{TA offset} indicates a valued fixed by a frame structure. Tₛ indicates a sampling period. Here, when the timing alignment value (N_{TA}) is positive (+), it is commanded that the uplink timing is adjusted so as to be advanced, and when the timing alignment value (N_{TA}) is negative (−), it is commanded that the uplink timing is adjusted so as to be delayed.

In order to perform the uplink synchronization, the mobile station may receive a TA value provided by the base station and apply the timing advance based on the TA value, thereby acquiring the synchronization for wireless communication with the base station.

Hereinafter, an application of multiple timing advance will be described.

In the multiple carrier system, a single mobile station communicates with the base station through the plurality of component carriers or the plurality of serving cells. When each of the signals of the plurality of serving cells set for the mobile station has different time delays, it is required for the mobile station to apply different TAs to each serving cell.

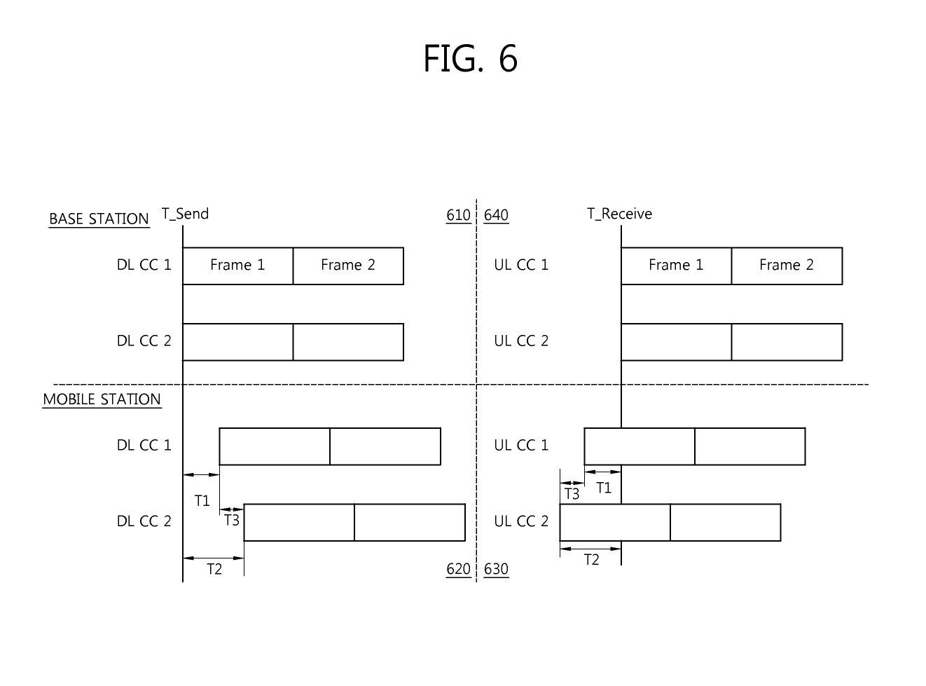

FIG. 6 is a diagram showing a process of applying uplink timing alignment values using downlink timing alignment values of a primary serving cell and a secondary serving cell. DL CC1 and UL CC1 are the primary serving cells, and DL CC2 and UL CC2 are the secondary serving cells.

Referring to FIG. 6, when the base station transmits a frame through the DL CC1 and the DL CC2 at a point in time ‘T_Send’, the mobile station receives the frame through the DL CC1 and the DL CC2 (620). The mobile station receives the frame at a point in time delayed by a propagation delay time after the point in time ‘T_Send’ at which the base station transmits the frame. In the DL CC1, a propagation delay corresponding to T1 is generated, such that the frame is received at a point in time delayed by T1, and in the DL CC2, a propagation delay corresponding to T2 is generated, such that the frame is received at a point in time delayed by T2.

When it is assumed that a propagation delay time of the downlink transmission and a propagation delay time of the uplink transmission are the same as each other, the mobile station may apply TAs corresponding to T1 and T2 to the UL CC1 and the UL CC2, respectively, to transmit the frame the base station (630). As a result, the base station may receive the frame transmitted by the mobile station through the UL CC1 and the UL CC2 at a point in time ‘T_Receive’ set for uplink synchronization (640).

Hereinabove, the case in which the base station receives the UL CC1 and the UL CC2 through a single receiving apparatus has been assumed. Therefore, in the case in which the base station includes apparatuses capable of independently receiving each UL CC, the points in time ‘T_Receive’ set by the base station need not to be the same as each other with respect to all of the UL CCs. That is, the point in time ‘T_Receive’ may be set for each UL CC. However, points in time at which the uplink frames transmitted by the mobile stations using each UL CC arrives need to be same each other, that is, need to be the point in time ‘T_Receive’.

Meanwhile, in order to apply multiple TA, the base station transmits a plurality of TA related information to the mobile stations so that the mobile stations may perform a random access to each serving cell. In this case, it is also required to transmit information identifying to which mobile station and which serving cell the plurality of TA related information is applied. To this end, when a new message is used, an overhead in a limited resource may occur, and complexity of the random access may increase.

A method for performing a random access in a multiple carrier system that reduces the overhead and the complexity through signaling using an MAC control element (CE) of an existing random access response message will be described.

Hereinafter, a method for performing a random access according to the present invention will be described.

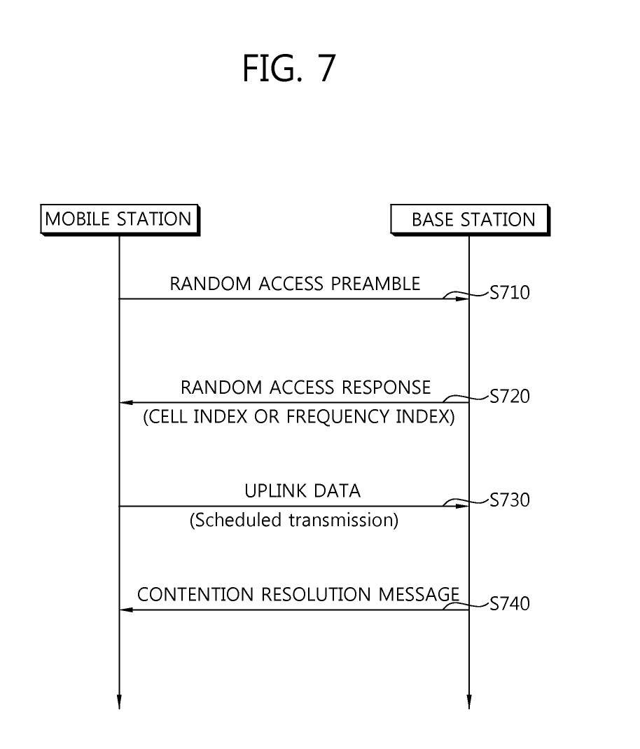

FIG. 7 is a flow chart explaining a random access procedure according to an exemplary embodiment of the present invention.

This procedure is a contention based random access procedure. The mobile station requires the uplink synchronization in order to transmit and receive data to and from the base station. The mobile station may perform a process of receiving information required for synchronization from the base station in order to perform the uplink synchronization. A random access process may also be applied in the case in which the mobile station is newly connected to a network through handover, or the like, and be performed in various situations such as a situation in which the mobile station is connected to the network and then changes a state of the synchronization or the RRC from the RRC idle state to the RRC connection station, and the like.

Referring to FIG. 7, the mobile station arbitrarily selects one preamble sequence in a set of random access preamble sequences and transmits a random access preamble according to the selected preamble sequence to the base station at step S710.

Here, the mobile station may recognize a random access-radio network temporary identifier (RA-RNTI) in consideration of a frequency resource and a transmission point in time that are temporarily selected in order to select a preamble or transmit a random access channel (RACH).

The base station transmits a random access response message as the received random access preamble of the mobile station to the mobile station at step S720. In this case, a physical downlink shared channel (PDSCH) is used. The random access response message may be transmitted in a format of an MAC protocol data unit (PDU).

A random access response message to the preamble transmitted by the mobile station is transferred to the mobile station through a primary serving cell. The PDCCH that serves to allocating resources of the corresponding PDSCH and specify positions is scrambled based on the RA-RNTI may be distinguished from the PDCCH having an RNTI value other than the RA-RNTI.

The mobile stations shall monitor the PDCCH of the a primary serving cell for random access response(s) identified by the RA-RNTI defined below, in the random access response window which starts at the subframe that contains the end of the preamble transmission plus three subframes and has length ‘ra-ResponseWindowSize’ subframes. The ra-ResponseWindowSize may be predetermined.

The RA-RNTI related to PRACH in which random access preamble is transmitted is calculated by the following Equation 2.

RA−RNTI=1+t_{id}+10×f_{id} Equation 2

Where t_{id} is the index of the first subframe of the specified PRACH (0≦t_{id}<10). And f_{id} is the index of a specified PRACH within that subframe, in an ascending order of frequency domain (0≦f_{id}<6).

For example, when f_{id} and t_{id} are different in each cell, the RA-RNTI value may be determined based on the smallest value among several f_{id} and t_{id} values. Therefore, each of the f_{id} and t_{id} value may be determined to be a single value with respect to a single mobile station.

That means, one RA-RNTI value is determined for one mobile station because the RA-RNTI value is determined based on the smallest value among values which are calculated in each cell although position which PRACH is transmitted is different in each cell and f_{id} and t_{id} are different in each cell.

As another example, each cell may also have each RA-RNTI value according to the corresponding f_{id} and t_{id}. That is, RA-RNTI value is calculated differently in each cell by the position in which PRACH is transmitted in each cell

The random access response message includes a random access preamble identifier (RAPID) for identifying the mobile stations performing the random access, an identifier of the base station, a temporary identifier of the mobile station such as a temporary C-RNTI, information on a time slot in which the random access preamble of the mobile station is received, uplink radio resource allocation information, or TA information for uplink synchronization of the mobile station. The random access preamble identifier is to identify the received random access preamble.

Meanwhile, according to the present invention, in order to apply the multiple TA, the base station transmits a plurality of TA information to the mobile station so that the mobile station may perform the random access to each serving cell. The base station transmits TA information on the secondary serving cell as well as the primary serving cell. The plurality of TA information on the primary serving cell and the secondary serving cell may be included in the random access response message and then transmitted. In this case, it is required to identify to which mobile station or which serving cell each of the plurality of TA information is applied.

The base station may identify the mobile stations through the preamble sequence, or the like. In addition, the mobile station receives serving cell identifying information from the base station, thereby making it possible to identify the serving cells to which the plurality of TA information is applied. Hereinafter, several examples of a method for identifying mobile stations and serving cells to which the TA information is applied will be described.

As an example, the base station may identify the mobile stations through a preamble sequence per the mobile station, and the mobile station may identify the serving cells using a cell index (First Example). The preamble sequence for identifying the mobile stations is called a preamble sequence per the mobile station. When the preamble sequence per the mobile station is determined in advance, only a single preamble sequence is applied to all of the serving cells (the primary serving cell and the secondary serving cell) with respect to one mobile station. Other mobile stations may not use this single preamble sequence per the mobile station.

Since the base station reads only the preamble sequence transmitted by the mobile station, an indicator capable of identifying the serving cells is required. The base station may identify the serving cells using the cell index. The cell index is an index for the primary serving cell or the secondary serving cell and information capable of identifying to which serving cell the corresponding information is related. The cell index may be included in the random access response message and then transmitted to the mobile station.

As another example, the base station newly defines a frequency index in the random access response message and then transmits the frequency index to the mobile station, such that the serving cells (or the mobile stations) to which the TA information is applied may be identified based on the frequency index (Second Example). Here, the frequency index means a frequency index of an uplink carrier used in one base station. For example, a physical cell identifier (PCI) may be used as the frequency index. The frequency indices are characterized in that they set to be the same as each other for all of the mobile stations with respect to the corresponding base station, unlike the cell indices that may be set to be different from each other for each mobile station.

As another example (Third Example), a base station may identify serving cells using a Carrier Indicator Field (CIF) in random access message. The CIF may be 3 bit and indicate values within 0˜7. Each value indicates index of serving cell.

When a mobile station performs resource allocations through PDCCH during cross carrier scheduling, the CIF indicates of which carrier (or serving cell) PDCCH orders resource allocation. For example, if CIF is ‘2’, CIF indicates that PDCCH orders resource allocations of ‘secondary serving cell 2’. Especially, when RAR MAC CE indicates only one serving cell, the CIF is useful.

According to this example, since timing information for the uplink synchronization is received through the random access response message, the mobile station may perform the uplink synchronization with the base station.

Then, the mobile station that has performed the uplink synchronization transmits uplink data to the base station through the PUSCH at a scheduling point in time determined based on the TA information at step S730. The uplink data may include an RRC connection request, a tracking area update, a scheduling request, or a buffer station report for data to be transmitted to the uplink by the mobile station. The uplink data may include a random access identifier, which may include a temporary C-RNTI, a C-RNTI (a status included in the mobile station), a mobile station contention resolution identifier, or the like.

Since the transmissions of the random access preambles by several mobile stations may collide with each other in a process of steps S710 to S730, the base station transmits a contention resolution (CR) message informing that the random access successfully ends to the mobile stations at S740. The contention resolution message may include a random access identifier, mobile station identifier information, or a C-RNTI. In a contention based random access process, the contention is generated since the number of possible random access preambles is limited. Since a unit random access preamble may not be imparted to all of the mobile stations in the cell, the mobile stations arbitrarily select and transmit one random access preamble in a set of random access preambles. Therefore, two or more mobile stations may select and transmit the same random access preamble through the same PRACH resource.

In this case, all of the transmissions of the uplink data fail or the base station successfully receives only uplink data of a specific mobile station according to positions or transmit power of the mobile stations. In the case in which the base station successfully receives the uplink data, the base station transmits the contention resolution message using the random access identifier included in the uplink data. The mobile station receiving its random access identifier may recognize that the contention resolution is successful. Allowing the mobile station to recognize whether the contention fails or succeeds in the contention based random access process is called the contention resolution.

When the mobile station receives the contention resolution message, the mobile station confirms whether the contention resolution message is its own. When it is confirmed that the contention resolution message is its own, the mobile station transmits ACK to the base station, and when it is confirmed that the contention resolution message is another mobile station's own, the mobile station does not transmit response data. In addition, the mobile station does not also transmit the response message in the case in which it misses downlink allocation is missed or may not decode the message.

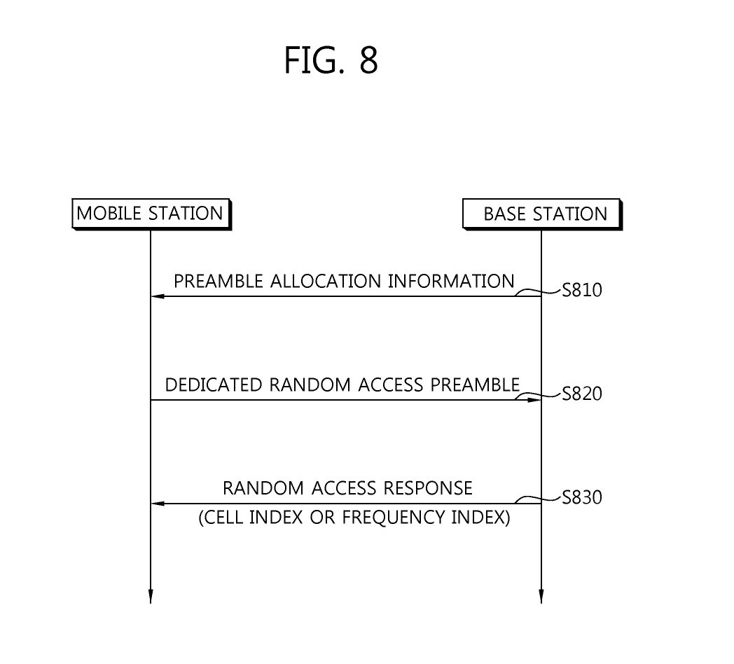

FIG. 8 is a flow chart explaining a random access procedure according to another exemplary embodiment of the present invention. This procedure is a non-contention based random access procedure.

Referring to FIG. 8, the base station selects one of dedicated random access preambles reserved in advance for the non-contention based random access procedure among all available random access preambles and transmits random access (RA) preamble assignment information including an index of the selected random access preamble and available time/frequency resource information to the mobile station at step S810. The mobile station needs to be allocated with a dedicated random access preamble that does not have collision possibility from the base station in order to perform a non-contention based random access process.

As an example, in the case in which the random access process is performed during a handover process, the mobile station may obtain the dedicated random access preamble from a handover command message. Another example, in the case in which the random access process is performed by a request of the base station, the mobile station may obtain the dedicated random access preamble through the PDCCH, that is, the physical layer signaling. In this case, the physical layer signaling, which is a downlink control information (DCI) format 1A, may include fields as shown in Table 1.

TABLE 1
Carrier indicator field: CIF—0 or 3 bits.
Flag for identifying formats 0/1A—1 bit (in the case in which the flag is 0,
it indicates the format 0, and in the case in which the flag is 1, it indicates
the format 1A).
In the case in which a format 1A CRC is scrambled by a C-RNTI and
remaining fields are set as follows, the format 1A is used for a random
access procedure initiated by a PDCCH order.
Localized/distributed VRB allocation flag—1 bit. Set to 0.
Resource block allocation—┌ log₂(N_{RB}^{DL}(N_{RB}^{DL} + 1)/2 ┐ bits.
All bits are set to 1.
Preamble Index—6 bits
PRACH mask index—4 bits.
All remaining bits of the format 1A for simple scheduling allocation of a
single PDSCH codeword are set to 0.

Referring to Table 1, the preamble index is an index indicating one preamble selected among the dedicated random access preambles reserved in advance for the non-contention based random access procedure, and the PRACH mask index indicates available time/frequency resource information. The available time/frequency resource information indicates different resources according to a frequency division duplex (FDD) system and a time division duplex (TDD) system as shown in Table 2.

TABLE 2

| PRACH | | |
|---|---|---|
| mask index | Allowed PRACH (FDD) | Allowed PRACH (TDD) |
| 0 | All | All |
| 1 | PRACH resource index 0 | PRACH resource index 0 |
| 2 | PRACH resource index 1 | PRACH resource index 1 |
| 3 | PRACH resource index 2 | PRACH resource index 2 |
| 4 | PRACH resource index 3 | PRACH resource index 3 |
| 5 | PRACH resource index 4 | PRACH resource index 4 |
| 6 | PRACH resource index 5 | PRACH resource index 5 |
| 7 | PRACH resource index 6 | Reserved |
| 8 | PRACH resource index 7 | Reserved |
| 9 | PRACH resource index 8 | Reserved |
| 10 | PRACH resource index 9 | Reserved |
| 11 | All even-numbered PRACH | All even-numbered PRACH |
| | opportunities in time | opportunities in time |
| | domain, First PRACH | domain, First PRACH |
| | resource index in subframe | resource index in subframe |
| 12 | All odd-numbered PRACH | All odd-numbered PRACH |
| | opportunities in time | opportunities in time |
| | domain, First PRACH | domain, First PRACH |
| | resource index in subframe | resource index in subframe |
| 13 | Reserved | First PRACH resource |
| | | index in subframe |
| 14 | Reserved | Second PRACH resource |
| | | index in subframe |
| 15 | Reserved | Third PRACH resource |
| | | index in subframe |

The mobile station transmits the dedicated random access preamble selected based on the received information to the base station at step S820. The base station may confirm which mobile station has transmitted the random access preamble based on the received random access preamble and time/frequency resources.

The base station transmits a random access response message to the mobile station at step S830. Similar to the contention based random access response message described above, the non-contention based random access response message includes the cell index and the frequency index, thereby making it possible to identify the mobile stations and the serving cells to which the TA information is applied. That is, the above mentioned First and Second Examples may be similarly applied.

Meanwhile, unlike the contention based random access, the non-contention based random access includes a C-RNTI rather than the temporary identifier of the mobile station such as a temporary C-RNTI. The base station may identify the mobile stations to which the TA information is applied through this C-RNTI (Fourth Example). The reason is that the C-RNTI indicates a specific mobile station unlike the arbitrary C-RNTI, such that it may be used as information identifying the mobile stations. In this case, unlike the preamble sequence per the mobile station in First Example of the contention based random access described above, a preamble sequence is not limited.

The random access response message is transmitted to the mobile station through a physical downlink control channel (PDSCH) indicated by the PDCCH scrambled by the cell-radio network temporary identifier (C-RNTI) of the mobile station.

Unlike the contention based random access process, in the non-contention based random access process, the random access response message is received, thereby judging that the random access process is normally performed and ending the random access process. The number of mobile stations having the same RA-RNTI is only one, such that a contention resolution (CR) procedure is not required.

In the case in which the preamble index in the preamble allocation information received by the mobile station is ‘000000’, the mobile station randomly selects one of the contention based random access preambles, sets the PRACH mask index to ‘0’, and then perform the contention procedure. In addition, the preamble allocation information may be transmitted to the mobile station through an upper layer message such as the RRC (for example, mobility control information (MCI) in a handover command).

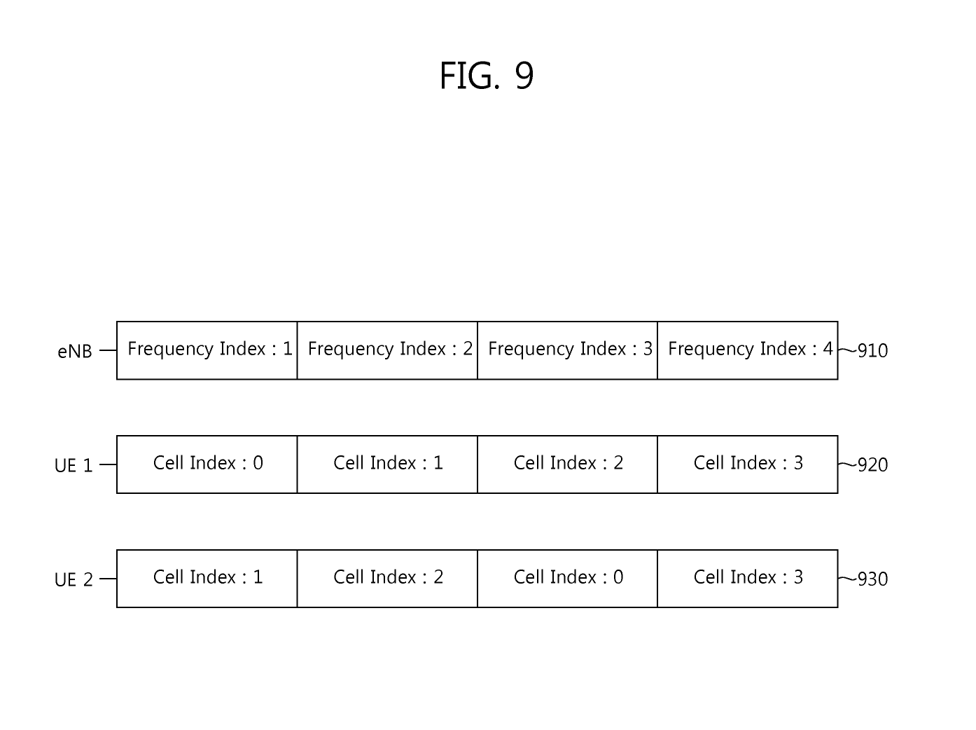

FIG. 9 is a diagram comparing a cell index and a frequency index with each other according to the present invention. The cell index is used in the above-mentioned First or Fourth Example, and the frequency index is used in the above-mentioned Second Example.

Referring to FIG. 9, all of the mobile stations recognize the same frequency index 910 with respect to a corresponding base station, unlike cell indices 920 and 930 that may be set to be different for each mobile station.

Hereinafter, a detailed structure of a random access response message according to the present invention will be described.

The random access response message may be divided into an MAC head, an MAC control element, and a padding. The MAC header is configured of a plurality of MAC sub-headers.

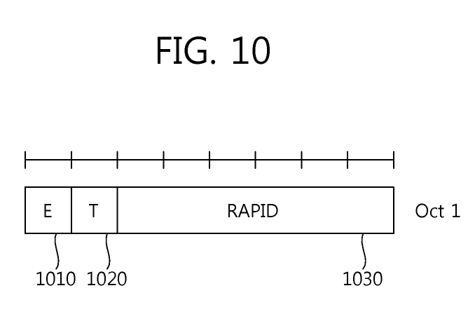

FIG. 10 shows an example of a random access preamble ID (RAPID) MAC sub-header according to the present invention.

Referring to FIG. 10, an extension (E) field 1010 is a flag indicating whether or not other fields are present in the MAC header. A type (T) field 1020 is a flag indicating whether or not the MAC sub-header includes an RAPID or a backoff indicator (BI). An RAPID field 1030 is used to identify the transmitted random access preamble.

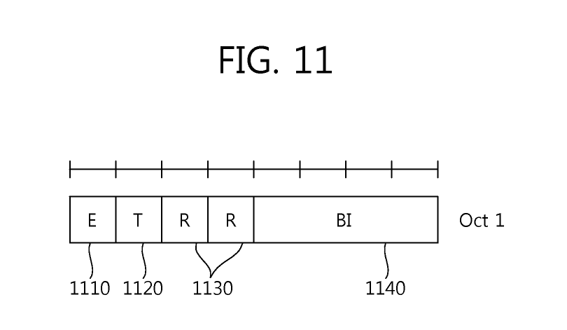

FIG. 11 shows an example of a backoff indicator (BI) MAC sub-header according to the present invention.

Referring to FIG. 11, an extension (E) field 1110 is a flag indicating whether or not other fields are present in the MAC header. A type (T) field 1120 is a flag indicating whether or not the MAC sub-header includes an RAPID or a BI. A reserved (R) field 1130 indicates a reserved bit. A BI field 1140 is used to identify when the next random access is attempted according to an overload state in the cell.

The BI filed is similarly applied to the following MAC control elements. That is, it is similarly applied to multiple cells suggested in the present invention. However, in the case in which the BI field is included in an MAC CE for the multiple cells suggested in the present invention, backoff of the multiple cells is commanded by the corresponding BI field. That is, the same backoff is commanded with respect to all of the cells that do not obtain a timing advance (TA) command by the RAPID in the MAC CE. The case in which the BI field is included in the MAC CE will be described in an example of the MAC control element.

Meanwhile, the cell index and the frequency index of First and Fourth Examples according to the present invention may be included in the MAC control element (CE) of the random access response message and then transmitted to the mobile station.

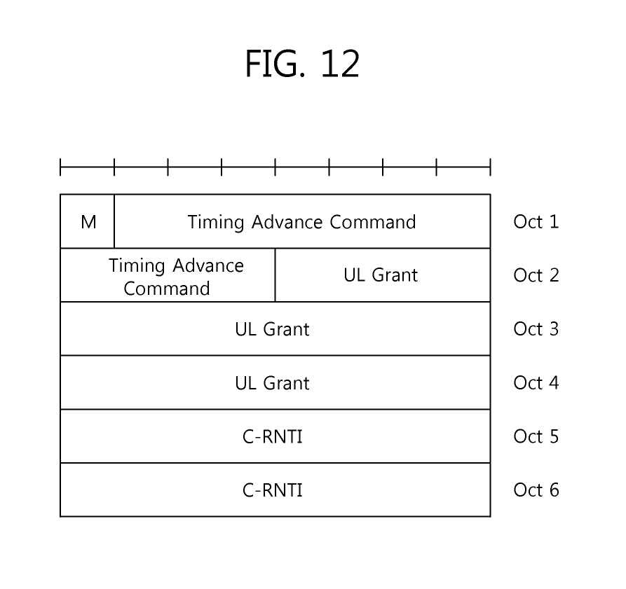

FIG. 12 shows an example of a structure of an MAC control element (CE) included in a random access response message according to the present invention.

Referring to FIG. 12, the MAC control element includes information on responses for each random access preamble. A timing advance command field (or a TA field) commands adjustment required for uplink transmission timing used for timing synchronization and may be 6 bits or 12 bits as an example. An uplink grant (UL Grant) field indicates a resource used for the uplink and may be 20 bits as an example. An arbitrary C-RNTI indicates an arbitrary identify used by the mobile station during the random access and may be 16 bits.

The MAC control element may further include a serving cell type indicator (an M field) indicating whether TA information included therein is related to the primary serving cell or the secondary serving cell. When the M field that is the serving cell type indicator has a value of 0, it indicates that the MAC control element includes the TA information related to the primary serving cell. When the M field has a value of 1, it indicates that the MAC control element includes the TA information related to several secondary serving cells.

In the case in which the M field that is the serving cell type indicator has a value of 0 and the MAC control element thus includes the TA information related to the primary serving cell, since the number of primary serving cells is only one, the MAC control element needs not to include an index related to other serving cells.

In the case in which the M field that is the serving cell type indicator is not included in the MAC control element, an RRC configuration message is used to inform the mobile station in an upper step that multiple TA is applied, thereby making it possible to identify information related to the primary serving cell and the secondary serving cell. That is, the serving cell type indicator may be included in the RRC configuration message as well as the MAC control element.

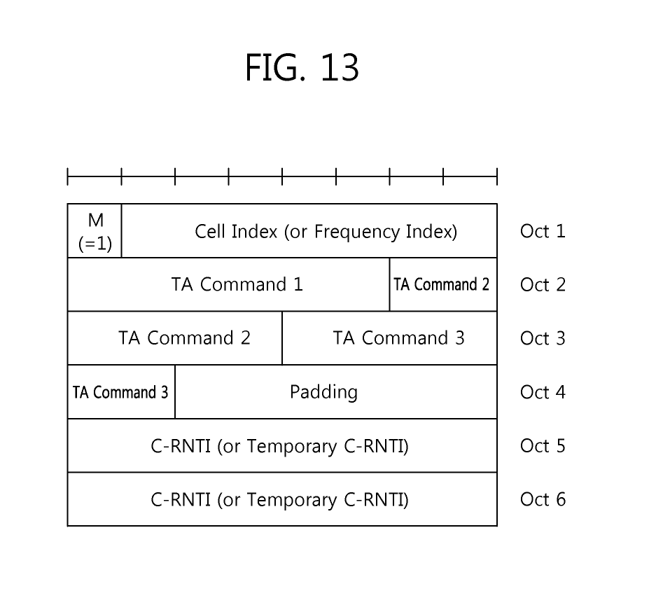

FIG. 13 shows another example of a structure of an MAC control element included in a random access response message according to the present invention. This case corresponds to the case in which the M field has a value of 1 to indicate that the MAC control element includes the TA information related to several secondary serving cells. The MAC control element including the TA information related to the secondary serving cells may indicate to which of a plurality of secondary servicing cells the TA information is related through the above-mentioned cell index or frequency index.

Referring to FIG. 13, the MAC control element includes a cell index or a frequency index. The cell index may indicate the secondary serving cells except for the primary serving cell. The reason is that the number of primary serving cells is only one, such that the primary serving cell may be indicated by the M field that is the serving cell type indicator.

The cell index may be 7 bits as an example. In this case, each bit may indicate one of a secondary serving cell 1 to a secondary serving cell 7 except for the primary serving cell. The frequency index may also indicate the secondary serving cells related to the TA information used by the mobile station for the uplink transmission. The frequency index may, for example, be a physical cell ID and have a length of 9 bits.

As another example, 3 bit carrier indicator field (CIF) may indicates one of secondary serving cells.

As another example, the cell index may not be included in a MAC CE. In situation that there is no confusion among preamble sequences per the mobile stations by scheduling of base stations and confusion among preamble sequences per cell in the mobile stations, identification based on the cell index may not be necessary. That is, by scheduling of the base station, existing RAR MAC CE structure may be reused. At that time, M bit which indicates a primary serving cell is kept as existing R bit. The R bit may be used as RESERVED bit for other use.

A TA command field (or a TA field) of the MAC control element includes the TA information related to the secondary serving cells indicated by the cell index or the frequency index and commands adjustment required for the uplink transmission timing used for the timing synchronization. The number of TA command fields may be plural, wherein each of the plurality of TA command fields may be 6 bits as an example. In the case of the plurality of TA command fields, may be disposed in a descending order from the largest index value or be disposed in an ascending order from the smaller index value. The number of TA command fields may be the same as the number of values set to 1 in the cell index (or the frequency index).

In addition, the MAC control element may include a C-RNTI (or arbitrary C-RNTI) field and have a size of 16 bits. A portion other than the above-mentioned fields may be a padding.

In the case of the non-contention based random access procedure, since the uplink grant field is not necessarily required in the MAC control element related to the secondary serving cells, the uplink grant field may not be included in the Mac control element. Since the C-RNTI (or arbitrary C-RNTI) is also not necessarily required, it may be omitted.

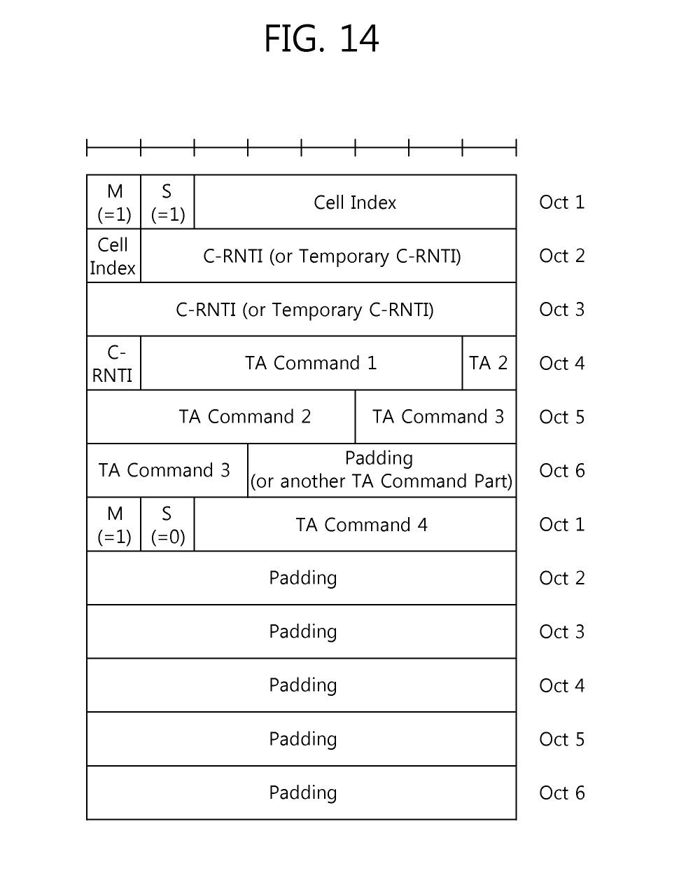

FIG. 14 shows still another example of a structure of an MAC control element included in a random access response message according to the present invention. In this structure, several MAC control elements including the TA information related to the secondary serving cells are bundled to be treated as one MAC control element.

Referring to FIG. 14, a plurality of MAC control elements may be bundled to be considered as one MAC control element. In the case in which the plurality of MAC control elements are bundled, a first MAC control element (corresponding to first 6 octets) includes other fields such as a cell index (or frequency index) field, a C-RNTI field, and the like, as well as the TA information. However, MAC control elements other than the first MAC control element may include only the TA command field without other fields. Therefore, it is possible to more space-efficiently transfer the TA information.

In this case, it needs to be indicated that a corresponding MAC control element is a portion of a bundle of MAC control elements, and it needs to be indicated to which position the MAC control element corresponds when the MAC control element is a portion of a bundle of MAC control elements. To this end, the MAC control element may include a bundle indicator (an S field). When the S field that is the bundle indicator is not present, the base station interprets that the respective MAC control elements are separate MAC control elements, such that an error may occur.

When the S field that is the bundle indicator has a value of 1, it indicates that an MAC control element is a first MAC control element in the bundle of MAC control elements, and when the S field that is the bundle indicator has a value of 0, it indicates that an MAC control element is an MAC control element other than the first MAC control element in the bundle of MAC control elements. When the S field that is the bundle indicator is not present, it may be judged that a corresponding MAC control element is not a portion of the bundle of MAC control elements.

In the case in which the MAC control element includes the TA information related to the primary serving cell (in the case in which the M field that is the serving cell type indicator has a value of 0), since the first MAC control element in the bundle of MAC control elements necessarily includes the TA information related to the primary serving cell, all of the S fields of the MAC control elements including the TA information related to the secondary serving cells will have a value of 0. That is, the S field of the MAC control element of which the M field has a value of 0 necessarily has a value of 0 rather than a value of 1. As a result, the S field of the corresponding MAC control element needs not to be interpreted.

On the other hand, the S field that is the bundle indicator has the meaning in connection with the MAC control element including the TA information related to the secondary serving cells. This case corresponds to the case in which the M field of the MAC control element has a value of 1.

In the case in which the M field has a value of 1, when the S field has a value of 1, it indicates that the corresponding MAC control element is a first MAC control element in the bundle of MAC control elements. According to the above-mentioned description, in this case, the primary serving cell is not included in the bundle of MAC control elements. Therefore, the corresponding MAC control element may include a cell index (or a frequency index), a C-RNTI (or arbitrary C-RNTI) value, or the like.

Meanwhile, when the S field has a value of 0, the corresponding MAC control element is an MAC control element other than the first MAC control element in the bundle of MAC control elements. However, since the first MAC control element includes the TA related identifying information including the cell index, the MAC control element other than the first MAC control element may include only the TA command field. Therefore, the cell index (or the frequency index) may be omitted. Further, in the case of the non-contention based random access, the uplink grant and the C-RNTI (or the arbitrary C-RNTI) may also be omitted. In the case in which the plurality of MAC control elements are interpreted as the bundle of MAC control elements as described above, more TA command fields may be included as compared to the case in which the plurality of MAC control elements are interpreted as a single MAC control element.

Meanwhile, for the purpose of backward compatibility, each of the MAC control elements configuring the bundle of MAC control elements is present in 6 octet unit. A portion other than the TA command field of the MAC control element may be padded.

The TA command field commands adjustment required for the uplink transmission timing used for the timing synchronization. The number of TA command fields may be plural, wherein each of the plurality of TA command fields may be 6 bits as an example. In the case of the plurality of TA command fields, may be disposed in a descending order from the largest index value or be disposed in an ascending order from the smaller index value. The number of TA command fields may be the same as the number of values set to 1 in the index.

Meanwhile, in the case in which the maximum number of TAs (or groups of TAs) is limited, the S field may not also be added. That is, in the case in which the maximum number of TAs is limited to 2, even though all possible TA commands are added, they may not exceed 6 octets which is a size of a single MAC control element. In this case, an extension MAC control element bundling structure through the S field is not required, and the S field is not required.

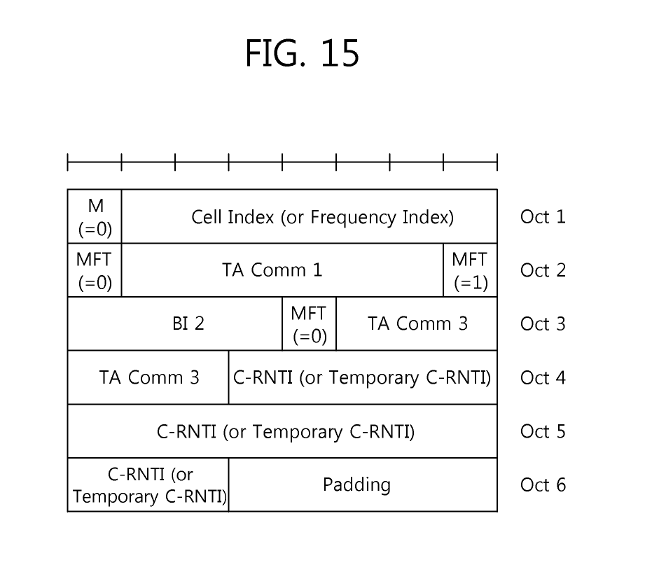

FIG. 15 shows still another example of a structure of an MAC control element included in a random access response message according to the present invention. This case corresponds to the case in which the M field has a value of 1 to indicate that the MAC control element includes the TA information related to several secondary serving cells. The MAC control element including the TA information related to the secondary serving cells may indicate to which of a plurality of secondary servicing cells the TA information is related through the above-mentioned cell index or frequency index.

Referring to FIG. 15, a structure of an MAC control element in which BI fields are differently applied to each cell unlike the exemplary embodiment of FIG. 13 is shown. The corresponding BI fields commands backoff values for cells indicated by each TA information, respectively. As a field identifying whether the TA command field is applied to the corresponding cell or the BI field is applied thereto, a multiple TA field type (MFT) field is used. When the MFT is 0, the TA command field follows the corresponding cell, and when the MFT is 1, the BI field follows the corresponding cell.

With respect to the cell receiving the BI field, the mobile station performs the backoff according to a command of the corresponding field.

As an example, the MAC CE of FIG. 15 corresponds to the case in which the mobile station obtains the TA value for the first cell and does not receive the TA value for the second cell. In this case, the base station sets a value of the MFT to 1 in order to represent that the BI is required for the second cell, thereby configuring the MAC. Here, the BI is set and transmitted in order to allow the base station to prevent the frames of the preambles transmitted from the plurality of mobile stations including the specific mobile station from colliding with each other in the same subframe (the same frequency band) in the corresponding cell, that is, prevent collision of the preambles in the corresponding mobile stations.

Here, the BI may be differently set for each cell.

In addition, the MFT may be differently set for each cell, corresponding to the setting of the BI or the TA.

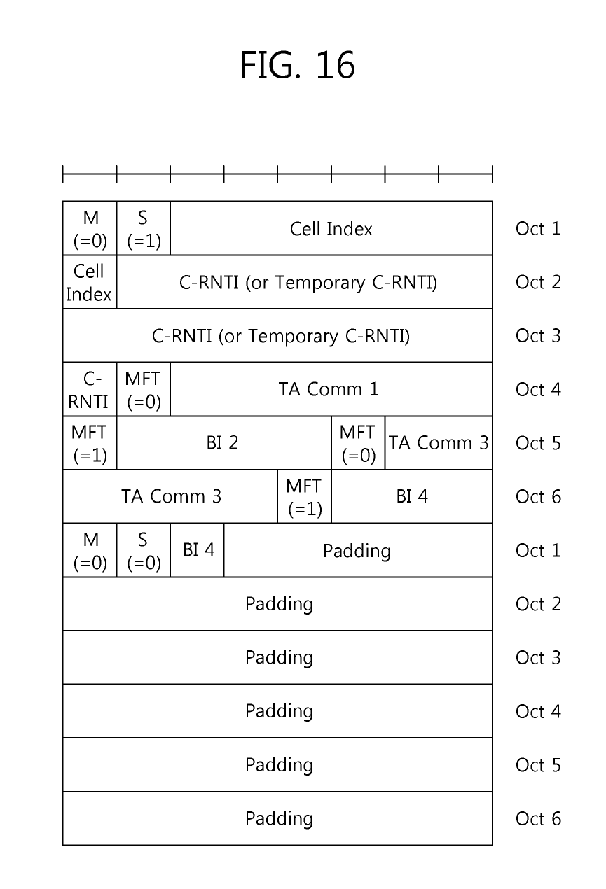

FIG. 16 shows another example of a structure of an MAC control element included in a random access response message according to the present invention.

Referring to FIG. 16, a structure in which several MAC control elements including the TA information related to the secondary serving cells are bundled to be treated as one MAC control element, that is, a structure in which the MAC CE form of FIG. 15 is indicated by a bundle of several MAC CEs is shown.

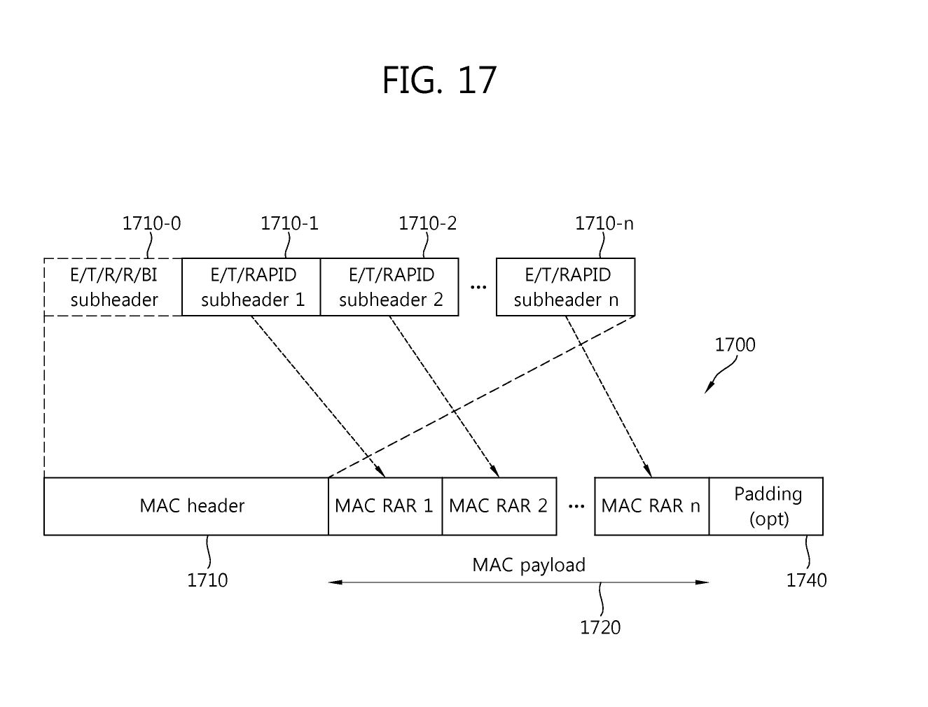

FIG. 17 shows a structure of an MAC PDU for a random access response and a mapping structure between an RAPID and the random access response. In the case in which only one preamble sequence is used in each mobile station, several sub-header will have the same RAPID value. As another example, sub-headers corresponding to an MAC RAR having the same MAC control element bundling structure will have the same RAPID value.

Referring to FIG. 17, an MAC PDU 1700 includes an MAC header 1710 and an MAC payload 1720. The MAC payload 1720 includes at least one MAC random access response (RAR). The MAC header includes at least one MAC sub-header, which is divided into an RAPID MAC sub-header and a backward indicator (BI) MAC sub-header. Each RAPID MAC sub-header corresponds to one MAC RAR. Selectively, the MAC PDU 1700 may also include a padding 1740.

The MAC header 1710 includes at least one sub-header 1710-0, 1710-1, 1710-2, . . . , 1710-n, wherein each sub-header 1710-0, 1710-1, 1710-2, . . . , 1710-n corresponds to a single MAC RAR or the padding 1740. A sequence of the sub-headers 1710-0, 1710-1, 1710-2, . . . , 1710-n is the same as that of the corresponding MAC RARs or the paddings 1740 in the MAC PDU 1700.

Each sub-header 1710-0, 1710-1, 1710-2, . . . , 1710-n may include five field, that is, E, T, R, R, and BI fields, or three fields, that is, E, T, and RAPID fields. The sub-header including five fields is a sub-header corresponding to the MAC header 1710, and the sub-header including three fields is a sub-header corresponding to the MAC RAR.

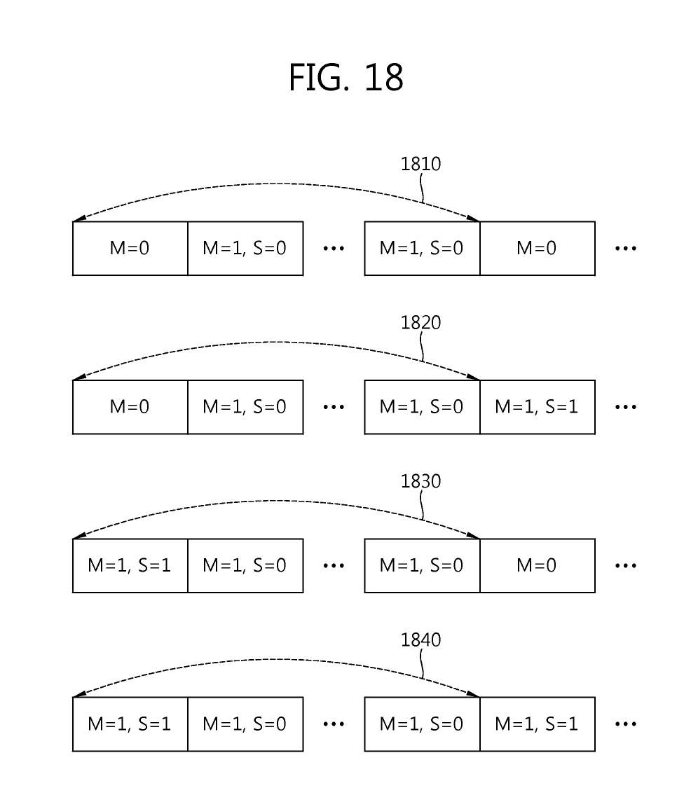

FIG. 18 shows MAC control elements present in a bundle according to the present invention.

Referring to FIG. 18, in the case in which an M field has a value of 0, it indicates the MAC control element including primary serving cell TA information. In the case in which the M field has a value of 1 (in the case of the MAC control element including the TA information related to the secondary serving cells), when an S field has a value of 1, it indicates a first secondary serving cell MAC control element in a bundle of MAC control elements, and when the S field has a value of 0, it indicates secondary serving cell MAC control elements other than the first secondary serving cell MAC control element.

Therefore, in the case in which the RAR MAC control elements are present in a bundle, as an example, the primary serving cell MAC control element (M=0) to an MAC control element prior to another primary serving cell MAC control element (M=0) may be interpreted as one bundle (1810).

As another example, the primary serving cell MAC control element (M=0) to an MAC control element prior to the first secondary serving cell MAC control element (M=1, S=1) may be interpreted as one bundle (1820).

As still another example, the first secondary serving cell MAC control element (M=1, S=1) to an MAC control element prior to another primary serving cell MAC control element (M=0) may be interpreted as one bundle (1830).

As still another example, the first secondary serving cell MAC control element (M=1, S=1) to an MAC control element prior to another first secondary serving cell MAC control element (M=1, S=1) may be interpreted as one bundle (1840).

The MAC control element other than the first MAC control element in the bundle of MAC control elements may be configured only of the TA command field and include an M field having a value of 1 and an S field having a value of 0.

In the multiple TA described above with reference to FIGS. 4 to 18, in connection with the preamble sequence allocation, a contention based preamble sequence for the multiple TA may be mapped into a non-contention based preamble sequence having a version in which the multiple TA is not supported. In the version in which the multiple TA is not supported, the contention based preamble sequence for the multiple TA is signaled to an area of the non-contention based preamble sequence. However, in the mobile station or the base station in which the multiple TA is supported, an area of the contention based preamble sequence for the multiple TA may be separately present in the area of the non-contention based preamble sequence. The corresponding signaling may be transferred from the base station to the mobile station through the RRC signaling.

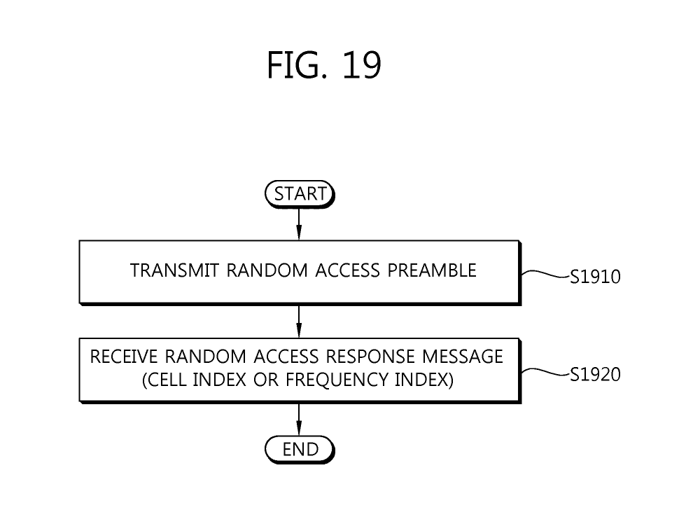

FIG. 19 is a flow chart showing an operation of a mobile station performing the random access procedure according to the exemplary embodiment of the present invention.

Referring to FIG. 19, the mobile station transmits a random access preamble to the base station at step S1910. The mobile station may arbitrarily select one preamble sequence in a set of random access preamble sequences and first transmit the random access preamble according to the selected preamble sequence to the base station.

However, in the case of the non-contention based random access, the operation of the mobile station performing the random access procedure may further include, before step S1910, selecting, in the base station, one of the dedicated random access preambles reserved in advance for the non-contention based random access procedure among all the available random access preambles and receiving, in the mobile station, random access preamble allocation information including an index of the selected random access preamble and available time/frequency resource information. The reason is that the mobile station needs to be allocated with a dedicated random access preamble that does not have collision possibility from the base station in order to perform a non-contention based random access process.

The mobile station receives a random access response message as a response to the random access preamble from the base station at step S1920. In this case, the PDSCH channel may be used, and the random access response message may be transmitted in a format of the MAC PDU.

The random access response message may include a random access preamble identifier (RAPID) for identifying the mobile stations performing the random access, an identifier of the base station, a temporary identifier of the mobile station such as a temporary C-RNTI, information on a time slot in which the random access preamble of the mobile station is received, uplink radio resource allocation information, or TA information for uplink synchronization of the mobile station.

Particularly, when the mobile station performs the random access to each serving cell for multiple TA, the base station transmits the plurality of TA information to the mobile station, wherein the plurality of TA information on the primary serving cell and the secondary serving cells may be included in the random access response message and then transmitted.

In addition, the random access response message may include the cell index and the frequency index in order to identify the mobile stations and the serving cells to which the plurality of TA information is applied. As described above with reference to FIGS. 12 to 14, the cell index or the frequency index may be included in the MAC control element of the random access response and then transmitted.

Then, the mobile station may perform the uplink synchronization with the base station using the TA information and the cell index or the frequency index. In the case of the non-contention based random access, the mobile station may use the C-RNTI value included in the random access response message to identify the MAC control element pertaining to the corresponding mobile station.

The TA value included in the TA command may be applied based on the uplink transmission of the primary serving cell or be applied based on the uplink transmission of each of the secondary serving cells regardless of the primary serving cell.

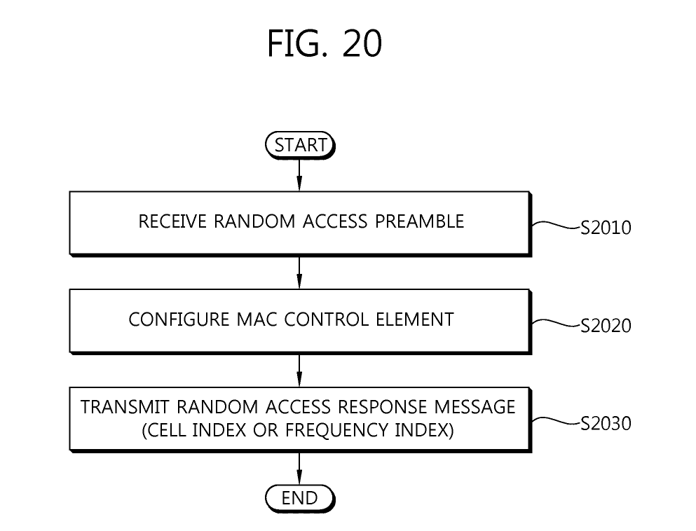

FIG. 20 is a flow chart showing an operation of a base station performing the random access procedure according to the exemplary embodiment of the present invention.

Referring to FIG. 20, the base station receives the random access preamble from the mobile station at step S2010. However, in the case of the non-contention based random access, the operation of the base station performing the random access procedure may further include, before step S2010, selecting, in the base station, one of the dedicated random access preambles reserved in advance for the non-contention based random access procedure among all the available random access preambles and transmitting the random access preamble allocation information including the index of the selected random access preamble and the available time/frequency resource information to the mobile station. The reason is that the dedicated random access preamble that does not have collision possibility needs to be allocated in order to perform the non-contention based random access process.

Then, the base station configures the MAC control element of the random access response message to be transmitted to the mobile station at step S2020. The random access response message may include a random access preamble identifier (RAPID) for identifying the mobile stations performing the random access, an identifier of the base station, a temporary identifier of the mobile station such as a temporary C-RNTI, information on a time slot in which the random access preamble of the mobile station is received, uplink radio resource allocation information, or TA information for uplink synchronization of the mobile station.

The MAC control element of the random access response message may include the plurality of TA information on the primary serving cell and the secondary serving cells so that the mobile stations may perform the random access to each serving cell in order to apply the multiple TA.

In addition, the random access response message may be configured to include the cell index and the frequency index in order to identify the mobile stations and the serving cells to which the plurality of TA information is applied. As described above with reference to FIGS. 12 to 14, the cell index or the frequency index may be configured to be included in the MAC control element of the random access response.

The mobile station receives the random access response message including the cell index or the frequency index from the base station at step S2030. In this case, the PDSCH channel may be used, and the random access response message may be transmitted in a format of the MAC PDU.

Then, the mobile station may perform the uplink synchronization with the base station using the TA information and the cell index or the frequency index.

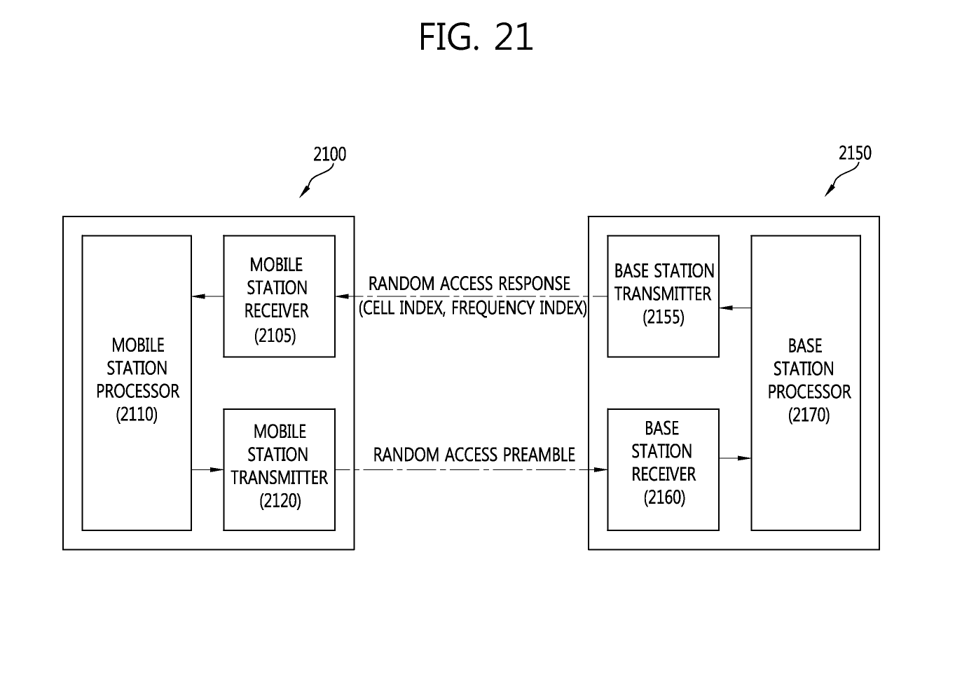

FIG. 21 is a block diagram showing the base station and the mobile station performing the random access procedure according to the exemplary embodiment of the present invention.

Referring to FIG. 21, the mobile station 2100 includes a mobile station receiver 2105, a mobile station processor 2110, and a mobile station transmitter 2120.

The mobile station receiver 2105 may receive the preamble allocation information, the random access response message, the RRC connection setting message, the RRC connection reconfiguring message, or the contention resolution message from the base station 2150. The random access response message may include the MAC control element as shown in FIGS. 12 to 14. Here, the MAC control element may include the cell index and the frequency index.

The mobile station receiver 2105 may receive a random access response message to the preamble transmitted by the mobile station through a primary serving cell. The random access response message may be transmitted through PDSCH. The PDCCH that serves to allocating resources of the corresponding PDSCH and specify positions is scrambled based on the RA-RNTI may be distinguished from the PDCCH having an RNTI value other than the RA-RNTI.

The mobile station 2100 shall monitor the PDCCH of the a primary serving cell for random access response(s) identified by the RA-RNTI, in the random access response window which starts at the subframe that contains the end of the preamble transmission plus three subframes and has length ‘ra-ResponseWindowSize’ subframes. The ra-ResponseWindowSize may be predetermined as the Equation 2. One RA-RNTI value may be determined for one mobile station.

The processor 2110 processes the non-contention based or the contention based random access procedure. The processor 2110 generates the random access preamble in order to secure the uplink timing synchronization for the serving cell. The generated random access preamble may be the dedicated random access preamble allocated by the base station 2150.

The uplink timing regarding each serving cell is adjusted using the cell index or the frequency index with respect to the plurality of TA information in the random access response message received in the base station.

The mobile station transmitter 2120 transmits the random access preamble to the base station 2150.

The base station 2150 includes a base station transmitter 2155, a base station receiver, 2160, and a base station processor 2170.

The base station transmitter 2155 transmits the preamble allocation information, the random access response message, or the contention resolution message to the mobile station 2100.

The base station receiver 2160 receives the random access preamble from the mobile station 2100.

The base station processor 2170 selects one of the dedicated random access preambles reserved in advance for the non-contention based random access procedure among all the available random access preambles and generates the preamble allocation information including an index of the selected random access preamble and available time/frequency resource information. In addition, the base station processor 2170 generates the random access response message or the contention resolution message.

Further, the base station processor 2170 configures the TA information transmitted to the mobile station and generates the random access response message including the cell index and the frequency index. As an example, the cell index and the frequency index may be configured to be included in the MAC control element of the random access response message. The examples of the MAC control element have been described with reference to FIGS. 12 to 14.

The TA command commands a relative change in uplink timing for current uplink timing and may be an integer multiple, for example, 16 Ts, of sampling timing (Ts). The TA command may be represented by a timing alignment value of a specific index.

According to the present invention, the mobile station receives timing information for uplink synchronization through a plurality of serving cells, thereby making it possible to perform the uplink synchronization with the base station.

According to the present invention, it is possible to more efficiently configure the random access response message transmitted to the mobile station by the base station in order to perform the uplink synchronization.

The spirit of the present invention has been just exemplified. It will be appreciated by those skilled in the art that various modifications and alterations can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

1. A method for performing a random access by a mobile station in a wireless communication system, the method comprising:
transmitting a random access preamble on at least one serving cell to a base station; and
receiving a Physical Downlink Control Channel (PDCCH) scrambled based on a Random Access-Radio Network Temporary Identifier (RA-RNTI) calculated in each serving cell based on a first subframe index of Physical Random Access Channel (PRACH) on which the random access preamble transmitted and a frequency index of the PRACH from the base station; and
receiving a random access response message through Physical Downlink Shared Channel (PDSCH) as a response to the random access preamble from the base station, based on the PDCCH.

2. The method of claim 1, further comprising monitoring whether the PDCCH is transmitted based on the RA-RNTI,
wherein receiving the PDCCH based on the monitoring.

3. The method of claim 1, wherein the monitoring is performed within a random access response window which starts from third subframe after the subframe including the end of transmission of the random access preamble.

4. The method of claim 1, wherein the RA-RNTI is determined as the smallest value among the values calculated in each of the at least one serving cell.

5. The method of claim 1, wherein the RA-RNTI is calculated in each of the at least one serving cell based on the position on which the PRACH is transmitted.

6. The method of claim 1, wherein the random access response message includes a carrier indicator field (CIF) which indicates of which carrier the PDCCH orders resource allocation.

7. The method of claim 1, wherein the random access response message includes at least one timing advance information applied to each of the at least one serving cell and a serving cell indicating field indicating a serving cell to which the at least one timing advance information is applied.

8. The method of claim 7, wherein the serving cell indicating field is a cell index field indicating whether the serving cell to which the at least one timing advance information is applied is a primary serving cell or a secondary serving cell and to which secondary serving cell the at least one timing advance information is applied in the case in which the number of secondary serving cells is plural.

9. The method of claim 7, wherein the serving cell indicating field is a frequency index field indicating a frequency of an uplink carrier used in the base station.

10. The method of claim 9, wherein the frequency index field is a physical cell ID.

11. The method of claim 10, wherein the serving cell indicating field is included in a media access control (MAC) control element (CE) of the random access response message.

12. The method of claim 11, wherein the MAC CE further includes a serving cell type indicator indicating whether each of the at least one timing advance information is related to a primary serving cell or a secondary serving cell.

13. The method of claim 7, wherein the random access response message includes a plurality of MAC control elements, and
at least one of the plurality of MAC control elements includes a bundle indicator indicating whether it is a first MAC control element in a bundle of MAC control elements.

14. The method of claim 13, wherein at least one of the plurality of MAC control elements includes backoff indicator fields each indicating backoff values for cells indicated by TA information.

15. A mobile station for performing a random access in a wireless communication system, the mobile station comprising:
a transmitter transmitting a random access preamble on at least one serving cell to a base station; and
a receiver receiving a Physical Downlink Control Channel (PDCCH) scrambled based on a Random Access-Radio Network Temporary Identifier (RA-RNTI) calculated in each serving cell based on a first subframe index of Physical Random Access Channel (PRACH) on which the random access preamble transmitted and a frequency index of the PRACH; and receiving a random access response message through Physical Downlink Shared Channel (PDSCH) as a response to the random access preamble from the base station, based on the PDCCH.

16. A method for performing a random access by a base station in a wireless communication system, the method comprising:
receiving a random access preamble on at least one serving cell from a mobile station; and
transmitting a Physical Downlink Control Channel (PDCCH) scrambled based on a Random Access-Radio Network Temporary Identifier (RA-RNTI) calculated in each serving cell based on a first subframe index of Physical Random Access Channel (PRACH) on which the random access preamble transmitted and a frequency index of the PRACH, to the mobile station; and
transmitting a random access response message through Physical Downlink Shared Channel (PDSCH) as a response to the random access preamble to the mobile station, based on the PDCCH.

17. The method of claim 16, further comprising monitoring whether the PDCCH is transmitted based on the RA-RNTI,
wherein receiving the PDCCH based on the monitoring.

18. The method of claim 16, wherein the monitoring is performed within a random access response window which starts from third subframe after the subframe including the end of transmission of the random access preamble.

19. The method of claim 16, wherein the RA-RNTI is determined as the smallest value among the values calculated in each of the at least one serving cell.

20. A base station for performing a random access in a wireless communication system, the base station comprising:
a receiver receiving a random access preamble on at least one serving cell from a mobile station; and
a transmitter transmitting a Physical Downlink Control Channel (PDCCH) scrambled based on a Random Access-Radio Network Temporary Identifier (RA-RNTI) calculated in each serving cell based on a first subframe index of Physical Random Access Channel (PRACH) on which the random access preamble transmitted and a frequency index of the PRACH, to the mobile station; and transmitting a random access response message through Physical Downlink Shared Channel (PDSCH) as a response to the random access preamble to the mobile station, based on the PDCCH.
